(19) United States
(12) Patent Application Publication
(10) Pub. No.: US 2025/0211050 A1
(43) Pub. Date: Jun. 26, 2025

(54) COIL-RETENTION WEDGE FOR A STATOR SLOT

(71) Applicant: BHE Turbomachinery, LLC, Portland, OR (US)

(72) Inventor: Henry K. Obermeyer, Wellington, CO (US)

(21) Appl. No.: 18/999,880

(22) Filed: Dec. 23, 2024

Related U.S. Application Data
(60) Provisional application No. 63/614,175, filed on Dec. 22, 2023.

(51) Int. Cl. H02K 3/487; H02K 1/02; H02K 1/16; H02K 15/40

(52) U.S. Cl. CPC H02K 3/487; H02K 1/02; H02K 1/16; H02K 15/40

(57) ABSTRACT

A ferromagnetic, coil-retention wedge assembly for a stator slot that includes a non-magnetic, corrugated substrate having alternating ridges and grooves and a plurality of ferromagnetic wedges inserted into the grooves of the corrugated substrate.

### CROSS-REFERENCES TO RELATED APPLICATIONS

This patent application claims the benefit of provisional Application No. 63/614,175 filed Dec. 22, 2023. That application is incorporated into the present disclosure by this reference.

### TECHNICAL FIELD

The subject matter is related to an apparatus and methods for altering magnetic flux paths adjacent to the air gap of motors and generators while also retaining stator-coil windings within a stator slot.

### BACKGROUND

Magnetic flux, in prior-art motors and generators, is guided in the vicinity of the air gap (between the stator and the rotor) by the stator teeth. Stator slots between the stator teeth are typically rectangular with notches adjacent the air gap to retain insulating wedges. The insulating wedges retain the stator coils in the stator slots. Although random wound coils may be inserted wire-by-wire into slots of arbitrary shape, many formed coil types require radially outward insertion into nominally rectangular slots. This restricts the tooth geometry to symmetric, rectangular shapes, which also restricts the pathways for the magnetic flux because it is guided in the vicinity of the air gap by those stator teeth.

Configurations of the disclosed technology address shortcomings in the prior art.

### BRIEF DESCRIPTION OF THE DRAWINGS

FIG. 1 is an isometric view of an example stator, according to an example configuration.

FIG. 2 is a partially exploded, detail view of a portion of the example stator of FIG. 1 but leaving out the stator-coil windings to clarify other features.

FIG. 3 is an exploded view of an example coil-retention wedge assembly, according to an example configuration.

FIG. 4 is an isometric view of the coil-retention wedge assembly of FIG. 3, illustrating an example where substantially all of the grooves of the corrugated substrate contain a ferromagnetic wedge and a non-magnetic spacer.

FIG. 5 is an isometric view of the coil-retention wedge assembly of FIG. 4 where the coil-retention wedge assembly has been trimmed to fit into an example stator-slot notch of the stator of FIGS. 1 and 2.

FIG. 6 is an exploded view of another example coil-retention wedge assembly, according to an example configuration where the corrugated substrate has V-shaped grooves.

FIG. 7 is an isometric view of a variation for the corrugated substrate of FIG. 6, where the corrugated substrate includes recesses embossed into the corrugated substrate to accommodate the ferromagnetic wedge as well as fold lines to facilitate folding of the corrugated substrate.

FIG. 8 illustrates an example method of constructing a coil-retention wedge assembly for a stator slot.

### DETAILED DESCRIPTION

As described in this document, aspects are directed to a coil-retention wedge for use in the stators of motors, generators, synchronous condensers, and the like. The disclosed coil-retention wedge assembly includes ferromagnetic elements that are separated from each other to avoid eddy current losses. The ferromagnetic wedges are oriented within the coil-retention wedge assembly so as to better distribute the magnetic flux adjacent to the air gap, which contributes to higher torque and higher efficiency.

In accordance with configurations of the disclosed technology, ferromagnetic wedges provide a reduced reluctance magnetic flux pathway to one or both edges of the adjacent stator teeth and thereby provide higher torque and improved efficiency.

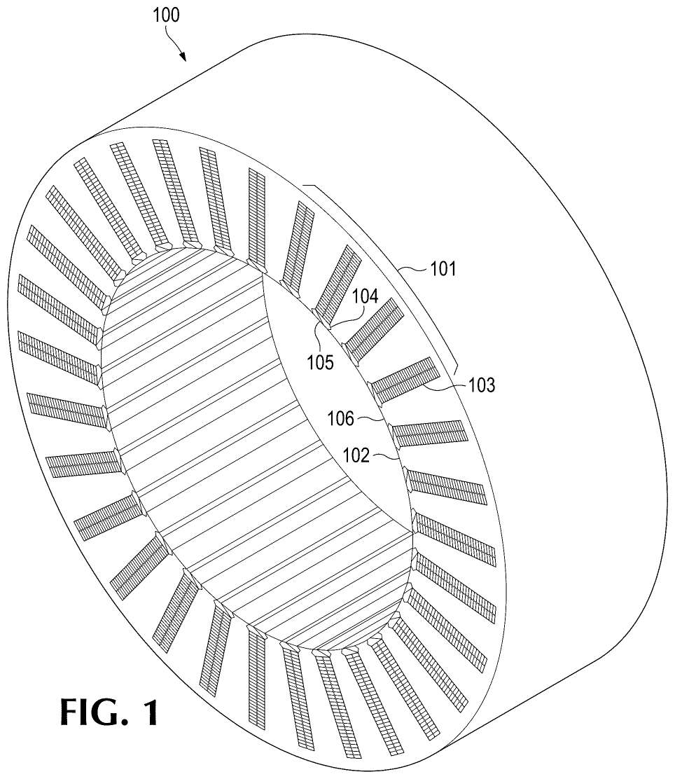

FIG. 1 is an isometric view showing portions of an example stator 100, according to an example configuration. The stator 100 may be, for example, a stator 100 in an electrical motor or an electrical generator. As illustrated in FIG. 1, the stator 100 may include an array of stator slots 101 that extend radially from an inner diameter 102 of the stator 100. The array of stator slots 101 contain the stator-coil windings 103. Each slot of the array of stator slots 101 has stator-slot notches 104 that are adjacent the inner diameter 102 of the stator 100. In the configuration illustrated in FIG. 1, each of the stator-slot notches 104 includes a coil-retention wedge assembly 105. The stator teeth 106 are between the stator slots 101.

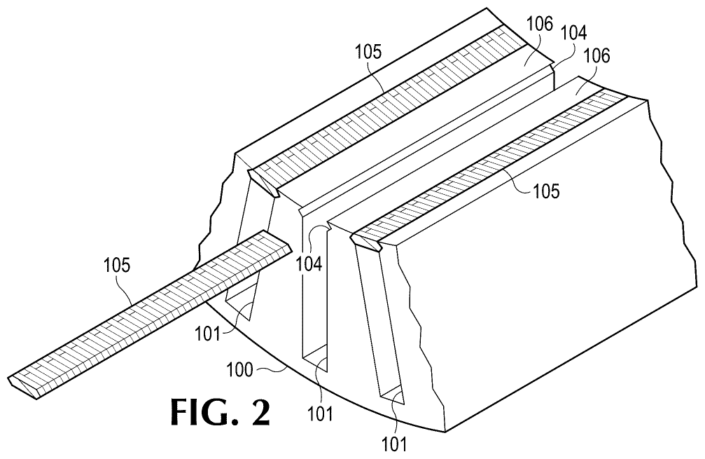

FIG. 2 is a partially exploded, detail view of a portion of the example stator 100 of FIG. 1 but leaving out the stator-coil windings 103 to clarify other features. FIG. 2 further clarifies the locations of the stator slots 101 and the stator-slot notches 104 within the stator 100 as well as the location of the coil-retention wedge assemblies 105 within the stator-slot notches 104.

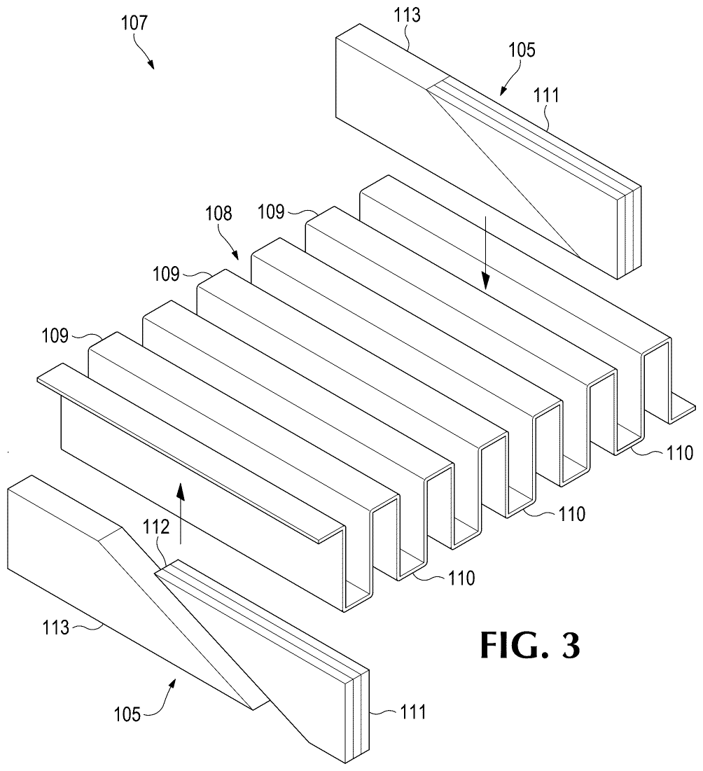

FIG. 3 is an exploded view of an example coil-retention wedge assembly 107, according to an example configuration. The coil-retention wedge assembly 107 of FIG. 3 could be used as the coil-retention wedge assembly 105 of FIG. 2. FIG. 4 is an isometric view of the coil-retention wedge assembly 107 of FIG. 3, illustrating an example where substantially all of the grooves 110 of the corrugated substrate 108 contain a ferromagnetic wedge 111 and a non-magnetic spacer 113. As illustrated in FIGS. 3 and 4, the coil-retention wedge assembly 107 may include a non-magnetic, corrugated substrate 108 having alternating ridges 109 and grooves 110. Hence, for example, the corrugated substrate 108 may be folded or otherwise formed into alternating ridges 109 and grooves 110. As illustrated, the undersides of the ridges 109 are the grooves 110 for the opposite side of the corrugated substrate 108. The corrugated substrate 108 may be, as examples, glass cloth, cellulose paper, aramid, or polyimide composite. In configurations, the corrugated substrate 108 is infused with epoxy resin, which may occur at any stage from before the substrate is folded to form a corrugated substrate 108 to after the trimmed wedge assemblies are secured into the stator-slot notch 104.

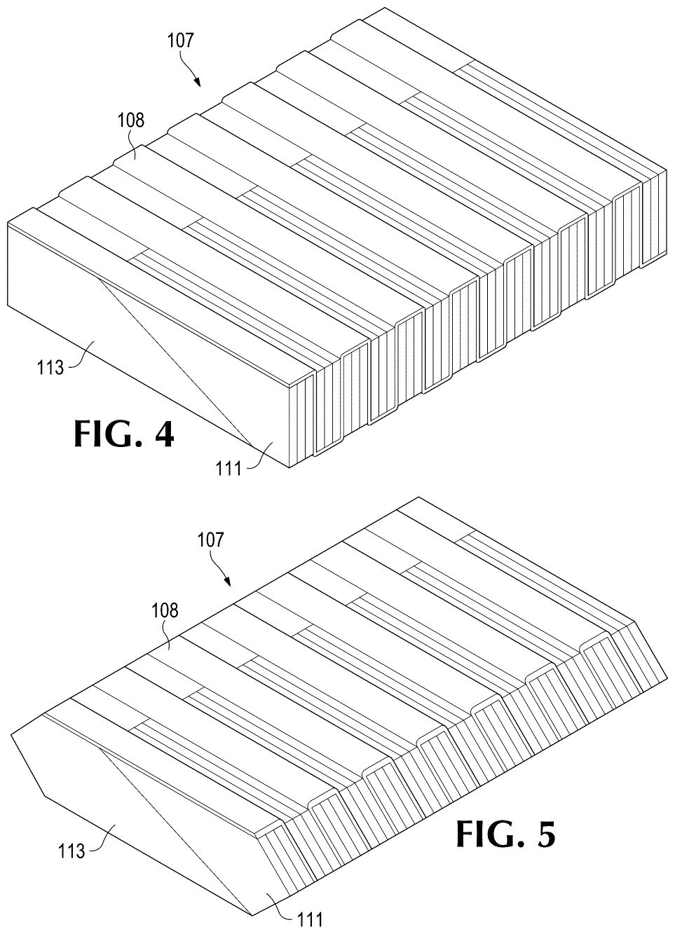

Ferromagnetic wedges 111 are inserted into the grooves 110 of the corrugated substrate 108. As best illustrated in FIG. 3, the ferromagnetic wedge 111 tapers to a thin point 112. Accordingly, the ferromagnetic wedge 111 may be triangular or right-trapezoidal in profile in some configurations (before being trimmed, as explained for FIG. 5). FIG. 3 illustrates an example of a ferromagnetic wedge 111 having the profile of a right trapezoid. In configurations, the ferromagnetic wedge 111 includes laminations of a ferromagnetic, amorphous-alloy core material. In configurations, the ferromagnetic, amorphous-alloy core material is a metallic glass made of a non-crystalline alloy. In configurations, the ferromagnetic, amorphous-alloy core material is a cobalt-based alloy. In configurations, the ferromagnetic wedge 111 is made of electrical steel. A purpose of the ferromagnetic wedges 111 is to minimize eddy currents that would otherwise be detrimental to efficiency.

As illustrated in FIGS. 3 and 4, in configurations the coil-retention wedge assembly 107 may optionally include a non-magnetic spacer 113 occupying a portion of the groove 110 of the corrugated substrate 108 that is not occupied by the ferromagnetic wedge 111. In configurations that do not have the non-magnetic spacer 113, the void left by omitting the non-magnetic spacer 113 could be filled with epoxy resin.

FIG. 5 is an isometric view of the coil-retention wedge assembly 107 of FIG. 4 where the coil-retention wedge assembly 107 has been trimmed to fit into an example stator-slot notch 104 of the stator 100 of FIGS. 1 and 2. Specifically, the example stator-slot notch 104 shown in FIG. 2 is not rectangular. So, the rectangular coil-retention wedge assembly 107 may need to be trimmed to fit within the stator-slot notch 104. Even after being trimmed, the ferromagnetic wedge 111 still tapers to a thin point 112.

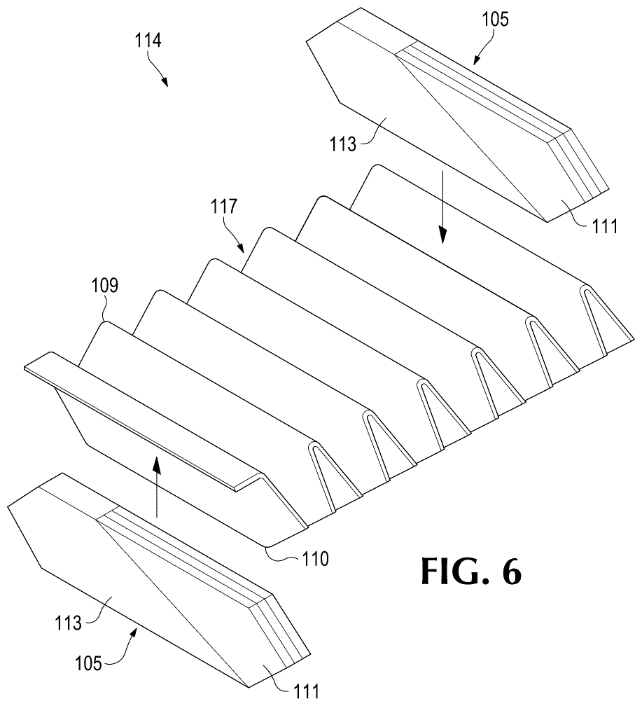

FIG. 6 is an exploded view of another example coil-retention wedge assembly 114, according to an example configuration. The coil-retention wedge assembly 114 of FIG. 6 could be used as the coil-retention wedge assembly 105 of FIG. 2. As illustrated, the corrugated substrate 117 of FIG. 6 has V-shaped grooves 110. Otherwise, the corrugated substrate 117 of FIG. 6 is as described above for the corrugated substrate 108 of FIGS. 3-5.

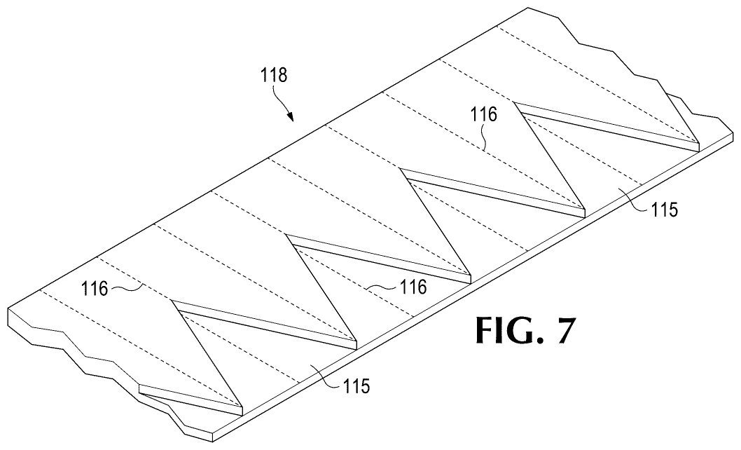

FIG. 7 is an isometric view of a variation for the corrugated substrate 117 of FIG. 6, where the corrugated substrate 118 of FIG. 7 further includes recesses 115 embossed into the corrugated substrate 118 to accommodate the thickness of the ferromagnetic wedge 111. In configurations, the corrugated substrate 118 may also include fold lines 116 to facilitate folding of the corrugated substrate 118. Accordingly, the corrugated substrate 118 of FIG. 7 may be folded around the ferromagnetic wedges 111. By contrast, the corrugated substrate 108 of FIGS. 3-5 is an example of a pre-formed corrugated substrate 108, where the ridges 109 and grooves 110 are present before the ferromagnetic wedges 111 are inserted into the grooves 110.

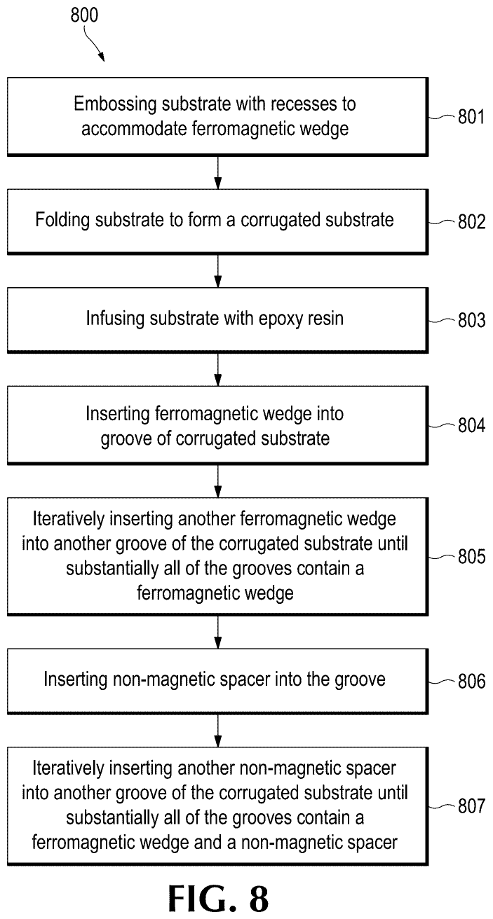

FIG. 8 illustrates an example method 800 of constructing a coil-retention wedge assembly for a stator slot. As illustrated in FIG. 8, the method 800 may include inserting 804 a ferromagnetic wedge into a groove of a non-magnetic, corrugated substrate, the corrugated substrate having alternating ridges and grooves.

In configurations, the method 800 may optionally include iteratively inserting 805 another ferromagnetic wedge into another groove of the corrugated substrate until substantially all of the grooves of the corrugated substrate contain a ferromagnetic wedge. In this context, “substantially all” means that every groove contains a ferromagnetic wedge or that ninety percent or more of the grooves contain a ferromagnetic wedge.

In configurations, the method 800 may optionally include infusing 803 the corrugated substrate with epoxy resin. As noted above, this infusing 803 with epoxy resin may occur at any stage from before folding 802 the substrate to form a corrugated substrate to after securing of the trimmed wedges into the stator-slot notch.

In configurations, the method 800 may optionally include embossing 801 the corrugated substrate with a recess to accommodate the thickness of the ferromagnetic wedge before inserting the ferromagnetic wedge into the groove of the corrugated substrate.

In configurations, the method 800 may also optionally include inserting 806 a non-magnetic spacer into the groove after inserting 804 the ferromagnetic wedge into the groove of the corrugated substrate. In such configurations, the method 800 may optionally include iteratively inserting 807 another ferromagnetic wedge and another non-magnetic spacer into another groove of the corrugated substrate until substantially all of the grooves of the corrugated substrate contain a ferromagnetic wedge and a non-magnetic spacer.

Accordingly, configurations of the disclosed ferromagnetic wedges provide a reduced reluctance magnetic flux pathway to one or both edges of the adjacent stator teeth. This is accomplished by “adding” ferromagnetic material to the stator teeth adjacent to the air gap by including the ferromagnetic material in the coil-retention wedge. The reduced reluctance magnetic flux pathway provides higher torque and improved efficiency as compared to a pathway with a higher reluctance, such as in designs utilizing prior-art insulating wedges.

### Examples

Illustrative examples of the disclosed technologies are provided below. A particular configuration of the technologies may include one or more, and any combination of, the examples described below.

Example 1 includes a ferromagnetic, coil-retention wedge assembly for a stator slot, the wedge assembly comprising: a non-magnetic, corrugated substrate having alternating ridges and grooves; and a plurality of ferromagnetic wedges inserted into the grooves of the corrugated substrate.

Example 2 includes the wedge assembly of Example 1, in which the plurality of ferromagnetic wedges comprise laminations of a ferromagnetic, amorphous-alloy core material.

Example 3 includes the wedge assembly of Example 2, in which the ferromagnetic, amorphous-alloy core material is a cobalt-based alloy.

Example 4 includes the wedge assembly of any of Examples 1-3, in which the plurality of ferromagnetic wedges comprise electrical steel.

Example 5 includes the wedge assembly of any of Examples 1-4, in which the corrugated substrate is infused with epoxy resin.

Example 6 includes the wedge assembly of any of Examples 1-5, in which each ferromagnetic wedge of the plurality of ferromagnetic wedges has a thickness, in which the corrugated substrate is embossed with recesses to accommodate the thickness of the ferromagnetic wedge.

Example 7 includes the wedge assembly of any of Examples 1-6, further comprising a plurality of non-magnetic spacers, each non-magnetic spacer of the plurality of non-magnetic spacers occupying a portion of the grooves of the corrugated substrate not occupied by a ferromagnetic wedge of the plurality of ferromagnetic wedges.

Example 8 includes a stator assembly for an electric motor or generator, the stator assembly comprising: a stator having an array of stator slots extending radially from an inner diameter of the stator, the array of stator slots containing stator-coil windings, each slot of the array of stator slots having a stator-slot notch adjacent the inner diameter of the stator; and a ferromagnetic, coil-retention wedge assembly within at least one stator-slot notch, the coil-retention wedge assembly comprising a non-magnetic, corrugated substrate having alternating ridges and grooves, and a plurality of ferromagnetic wedges inserted into the grooves of the corrugated substrate.

Example 9 includes the stator assembly of Example 8, in which the plurality of ferromagnetic wedges comprise laminations of a ferromagnetic, amorphous-alloy core material.

Example 10 includes the stator assembly of Example 9, in which the ferromagnetic, amorphous-alloy core material is a cobalt-based alloy.

Example 11 includes the stator assembly of any of Examples 8-10, in which the plurality of ferromagnetic wedges comprise electrical steel.

Example 12 includes the stator assembly of any of Examples 8-11, in which the corrugated substrate is infused with epoxy resin.

Example 13 includes the stator assembly of any of Examples 8-12, in which each ferromagnetic wedge of the plurality of ferromagnetic wedges has a thickness, in which the corrugated substrate is embossed with recesses to accommodate the thickness of the ferromagnetic wedge.

Example 14 includes the stator assembly of any of Examples 8-13, further comprising a plurality of non-magnetic spacers, each non-magnetic spacer of the plurality of non-magnetic spacers occupying a portion of the grooves of the corrugated substrate not occupied by a ferromagnetic wedge of the plurality of ferromagnetic wedges.

Example 15 includes a method of constructing a coil-retention wedge assembly for a stator slot, the method comprising inserting a ferromagnetic wedge into a groove of a non-magnetic, corrugated substrate, the corrugated substrate having alternating ridges and grooves.

Example 16 includes the method of Example 15, further comprising iteratively inserting another ferromagnetic wedge into another groove of the corrugated substrate until substantially all of the grooves of the corrugated substrate contain a ferromagnetic wedge.

Example 17 includes the method of any of Examples 15-16, further comprising infusing the corrugated substrate with epoxy resin.

Example 18 includes the method of any of Examples 15-17, in which the ferromagnetic wedge has a thickness, the method further comprising embossing the corrugated substrate with a recess to accommodate the thickness of the ferromagnetic wedge before inserting the ferromagnetic wedge into the groove of the corrugated substrate.

Example 19 includes the method of any of Examples 15-18, further comprising inserting a non-magnetic spacer into the groove after inserting the ferromagnetic wedge into the groove of the corrugated substrate.

Example 20 includes the method of any of Examples 19, further comprising iteratively inserting another ferromagnetic wedge and another non-magnetic spacer into another groove of the corrugated substrate until substantially all of the grooves of the corrugated substrate contain a ferromagnetic wedge and a non-magnetic spacer.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

I (or we) claim:

1. A ferromagnetic, coil-retention wedge assembly for a stator slot, the wedge assembly comprising:
a non-magnetic, corrugated substrate having alternating ridges and grooves; and
a plurality of ferromagnetic wedges inserted into the grooves of the corrugated substrate.

2. The wedge assembly of claim 1, in which the plurality of ferromagnetic wedges comprise laminations of a ferromagnetic, amorphous-alloy core material.

3. The wedge assembly of claim 2, in which the ferromagnetic, amorphous-alloy core material is a cobalt-based alloy.

4. The wedge assembly of claim 1, in which the plurality of ferromagnetic wedges comprise electrical steel.

5. The wedge assembly of claim 1, in which the corrugated substrate is infused with epoxy resin.

6. The wedge assembly of claim 1, in which each ferromagnetic wedge of the plurality of ferromagnetic wedges has a thickness, in which the corrugated substrate is embossed with recesses to accommodate the thickness of the ferromagnetic wedge.

7. The wedge assembly of claim 1, further comprising a plurality of non-magnetic spacers, each non-magnetic spacer of the plurality of non-magnetic spacers occupying a portion of the grooves of the corrugated substrate not occupied by a ferromagnetic wedge of the plurality of ferromagnetic wedges.

8. A stator assembly for an electric motor or generator, the stator assembly comprising:
a stator having an array of stator slots extending radially from an inner diameter of the stator, the array of stator slots containing stator-coil windings, each slot of the array of stator slots having a stator-slot notch adjacent the inner diameter of the stator; and
a ferromagnetic, coil-retention wedge assembly within at least one stator-slot notch, the coil-retention wedge assembly comprising a non-magnetic, corrugated substrate having alternating ridges and grooves, and a plurality of ferromagnetic wedges inserted into the grooves of the corrugated substrate.

9. The stator assembly of claim 8, in which the plurality of ferromagnetic wedges comprise laminations of a ferromagnetic, amorphous-alloy core material.

10. The stator assembly of claim 9, in which the ferromagnetic, amorphous-alloy core material is a cobalt-based alloy.

11. The stator assembly of claim 8, in which the plurality of ferromagnetic wedges comprise electrical steel.

12. The stator assembly of claim 8, in which the corrugated substrate is infused with epoxy resin.

13. The stator assembly of claim 8, in which each ferromagnetic wedge of the plurality of ferromagnetic wedges has a thickness, in which the corrugated substrate is embossed with recesses to accommodate the thickness of the ferromagnetic wedge.

14. The stator assembly of claim 8, further comprising a plurality of non-magnetic spacers, each non-magnetic spacer of the plurality of non-magnetic spacers occupying a portion of the grooves of the corrugated substrate not occupied by a ferromagnetic wedge of the plurality of ferromagnetic wedges.

15. A method of constructing a coil-retention wedge assembly for a stator slot, the method comprising inserting a ferromagnetic wedge into a groove of a non-magnetic, corrugated substrate, the corrugated substrate having alternating ridges and grooves.

16. The method of claim 15, further comprising iteratively inserting another ferromagnetic wedge into another groove of the corrugated substrate until substantially all of the grooves of the corrugated substrate contain a ferromagnetic wedge.

17. The method of claim 15, further comprising infusing the corrugated substrate with epoxy resin.

18. The method of claim 15, in which the ferromagnetic wedge has a thickness, the method further comprising embossing the corrugated substrate with a recess to accommodate the thickness of the ferromagnetic wedge before inserting the ferromagnetic wedge into the groove of the corrugated substrate.

19. The method of claim 15, further comprising inserting a non-magnetic spacer into the groove after inserting the ferromagnetic wedge into the groove of the corrugated substrate.

20. The method of claim 19, further comprising iteratively inserting another ferromagnetic wedge and another non-magnetic spacer into another groove of the corrugated substrate until substantially all of the grooves of the corrugated substrate contain a ferromagnetic wedge and a non-magnetic spacer.
